(19) United States
(12) Patent Application Publication
(10) Pub. No.: US 2024/0221975 A1
(43) Pub. Date: Jul. 4, 2024

(54) COMPOSITE WATER BLOCKING AND SHIELDING TAPE FOR WATER BLOCKING IN A COMPACT CABLE

(71) Applicant: PPC BROADBAND, INC., East Syracuse, NY (US)

(72) Inventor: Jordan CAVINESS, Liverpool, NY (US)

(73) Assignee: PPC BROADBAND, INC., East Syracuse, NY (US)

(21) Appl. No.: 18/399,510

(22) Filed: Dec. 28, 2023

Related U.S. Application Data
(60) Provisional application No. 63/436,306, filed on Dec. 30, 2022.

(51) Int. Cl. H01B 7/282; H01B 7/22

(52) U.S. Cl. CPC H01B 7/2825; H01B 7/226

(57) ABSTRACT

A composite water blocking shield includes: a first shield portion; an insulator portion surrounding the first shield portion; a second shield portion surrounding the insulator portion; and a water blocking portion surrounding the second shield portion. The insulator portion is adjacent to the first shield portion, the second shield portion is adjacent to the insulator portion, and the water blocking portion is adjacent to the second shield portion; the first shield portion, the insulator portion, the second shield portion, and the water blocking portion form a single tape that is configured to be applied to an outside of a portion of a cable as a single unit; and the composite water blocking shield provides radio frequency shielding and water blocking in a single tape so as to provide radio frequency shielding and water blocking in a compact cable.

### CROSS-REFERENCE TO RELATED APPLICATION

This application claims the benefit of U.S. Provisional Application No. 63/436,306 filed Dec. 30, 2022, which is currently pending, the disclosure of which is hereby incorporated by reference herein in its entirety.

### BACKGROUND

The present invention relates generally to cables. More particularly, the present invention relates to waterproofing and shielding tape for cables such as, for example, coaxial cables.

Coaxial cables are commonly used in the cable television industry to carry cable TV signals to television sets in homes, businesses, and other locations. A hardline coaxial cable may be used to carry the signals in distribution systems exterior to these locations and a flexible coaxial cable is then often used to carry the signals within the interior of these locations. Hardline or semi-rigid coaxial cable is also used where a high degree of radio-frequency (RF) shielding is required.

Although embodiments of the disclosure will be discussed using coaxial cables as an example, embodiments of the disclosure can be applied to other types of cables. An exemplary hardline coaxial cable can be used to carry signals in a distribution system and can be buried underground or supported above ground.

Some aerial coaxial cable is susceptible to water penetration via a damaged portion of the cable's outer sheath. Some cable has a layer of laminated tape for electrical shielding, but no water blocking capabilities. Some cable include a water blocking tape, but adding such tape to some cable configurations has disadvantages such as, for example, an increased thickness.

Some cables use a waterproofing liquid or gel. However, some waterproofing liquid or gel material is not appropriate for aerial installations because the liquid or gel can become less viscous at the high temperatures encountered in aerial installations. The reduction in viscosity can result in the waterproofing liquid or gel flowing away from some portions of the cable, thus reducing the water resistance in those areas.

It may be desirable to provide a cable waterproofing system that provides both RF shielding and waterproofing in a compact package.

### SUMMARY

In accordance with various embodiments of the disclosure, a shielding and water blocking tape provides radio frequency shielding and water blocking in a single tape so as to provide radio frequency shielding and water blocking in the cable in a compact cable.

Particular embodiments provide: a center conductor; a cable insulator portion surrounding the center conductor; a first shielding portion surrounding the cable insulator portion; a second shielding portion surrounding the first shielding portion; a composite portion surrounding the second shielding portion; and a sheath portion surrounding the composite portion. The composite portion may comprise a composite portion first shield portion; a composite portion insulating portion that may surround the composite portion first shield portion; a composite portion second shield portion that may surround the composite portion insulating portion; and a composite portion water blocking portion that may surround the composite portion second shield portion. The composite portion insulator portion may be adjacent to the composite portion first shield portion, the composite portion second shield portion may be adjacent to the composite portion insulating portion, and the composite portion water blocking portion may be adjacent to the composite portion second shield portion. The composite portion first shield portion, the composite portion insulating portion, the composite portion second shield portion, and the composite portion water blocking portion may form a single unit that may be configured to be applied to an outside of the second shielding portion as the single unit. The composite portion may provide radio frequency shielding and water blocking in a single tape so as to provide radio frequency shielding and water blocking in a compact cable.

According to various embodiments, the cable insulator portion may surround the center conductor in a radial direction, the first shielding portion may surround the cable insulator portion in the radial direction, the second shielding portion may surround the first shielding portion in the radial direction, the composite portion may surround the second shielding portion in the radial direction, and the sheath portion may surround the composite portion in the radial direction.

According to various embodiments, the first shielding portion may be an aluminum-polypropylene-aluminum layer.

According to various embodiments, the second shielding portion may be an aluminum braid layer.

According to various embodiments, the composite portion may be a four-layer tape.

According to various embodiments, the composite portion water blocking portion may be an absorbent powder.

According to various embodiments, the composite portion water blocking portion may be a water blocking tape.

According to various embodiments, the composite portion may be configured to be wound around the second shielding portion in a helical formation.

According to various embodiments, longitudinal edges of the composite portion may be configured to form a folded seam running in a direction of the center conductor of the cable.

Particular embodiments provide a composite water blocking shield for use in a cable including: a first shield portion; an insulator portion surrounding the first shield portion; a second shield portion surrounding the insulator portion; and a water blocking portion surrounding the second shield portion. The insulator portion may be adjacent to the first shield portion, the second shield portion may be adjacent to the insulator portion, and the water blocking portion may be adjacent to the second shield portion. The first shield portion, the insulator portion, the second shield portion, and the water blocking portion may form a single tape that may be configured to be applied to an outside of a portion of a cable as a single unit. The composite water blocking shield may provide radio frequency shielding and water blocking in a single tape so as to provide radio frequency shielding and water blocking in a compact cable.

According to various embodiments, a cable includes: a center conductor; a cable insulator portion surrounding the center conductor; a shielding portion surrounding the cable insulator portion; and the composite water blocking shield of claim 10 surrounding the shielding portion.

According to various embodiments, the composite water blocking shield may be configured to be wound around the shielding portion in a helical formation.

According to various embodiments, longitudinal edges of the composite water blocking shield may be configured to form a folded seam running in a direction of the center conductor of the cable.

According to various embodiments, the composite water blocking shield may be a four-layer tape.

According to various embodiments, the water blocking portion may be an absorbent powder.

According to various embodiments, the water blocking portion may be a water blocking tape.

Particular embodiments provide a composite water blocking shield for use in a cable including: a first shield portion; an insulator portion adjacent to the first shield portion; and a water blocking portion surrounding the insulator portion. The first shield portion, the insulator portion, and the water blocking portion may form a single tape that is configured to be applied to an outside of a portion of a cable as a single unit. The composite water blocking shield may provide radio frequency shielding and water blocking in a single tape so as to provide radio frequency shielding and water blocking in a compact cable.

According to various embodiments, further comprising a second shield portion adjacent to the insulator portion.

According to various embodiments, the insulator portion may be adjacent to the first shield portion, the second shield portion may be adjacent to the insulator portion, and the water blocking portion may be adjacent to the second shield portion.

According to various embodiments, the water blocking portion may be an absorbent powder.

According to various embodiments, the water blocking portion may be a water blocking tape.

According to various embodiments, the composite water blocking shield may be configured to be wound around a portion of a cable in a helical formation.

According to various embodiments, longitudinal edges of the composite water block shield may be configured to form a folded seam running in a direction of a center conductor of a cable.

Various aspects of the cable tape, as well as other embodiments, objects, features and advantages of this disclosure, will be apparent from the following detailed description of illustrative embodiments thereof, which is to be read in conjunction with the accompanying drawings.

### BRIEF DESCRIPTION OF THE DRAWINGS

FIG. 1 is a perspective view of a cable having no waterproofing.

FIG. 2 is a perspective view of a cable that includes a waterproofing tape.

FIG. 3 is a perspective view of an exemplary cable in accordance with embodiments of the disclosure.

FIG. 4 is a cross-sectional view of a waterproofing tape of the cable of FIG. 3.

### DETAILED DESCRIPTION OF EMBODIMENTS

Embodiments of the disclosure provide a composite water blocking shield that provides radio frequency shielding and water blocking in a single tape so as to provide radio frequency shielding and water blocking in a compact cable.

A cable outer sheath can be damaged by contact with a foreign object such as, for example, a fallen tree limb. Such damage can penetrate the outer sheath and allow water to penetrate the outer sheath and enter the inner layers of the cable. Such water penetration can cause reduced performance of shielding layers and, ultimately, degradation of the signal being transmitted by the cable.

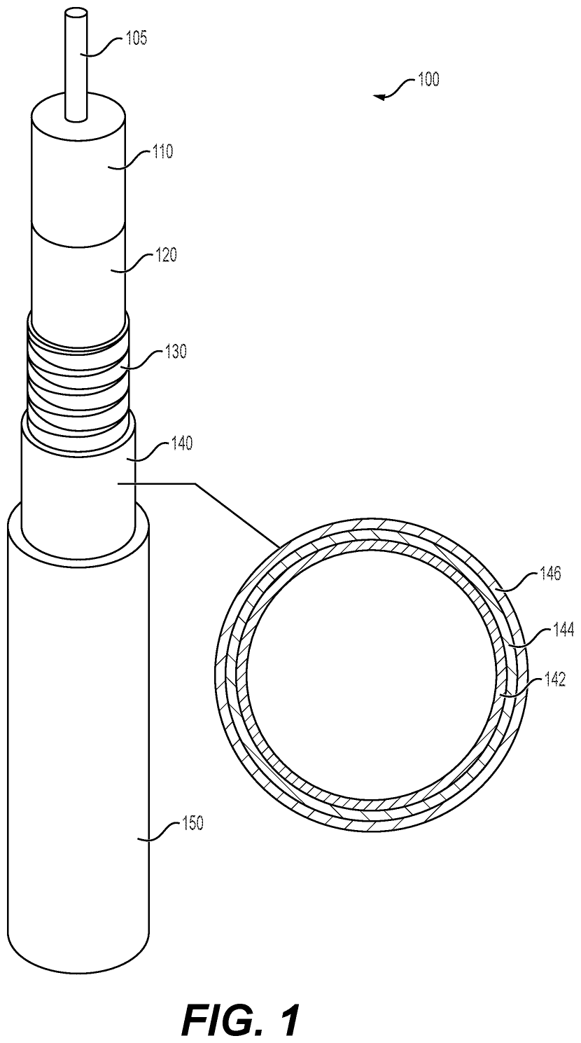

FIG. 1 shows a cable 100 having a center conductor 105 surrounded by a dielectric layer, 110. The dielectric layer 110 is covered by a tape 120 that is an aluminum-polypropylene-aluminum (APA) laminated tape that is an RF shield. In this example, an aluminum braid shield 130 covers the APA tape 120. In this example, the aluminum braid shield 130 is covered by another layer of APA laminated tape 140. An outer protective sheath, 150 covers the APA laminated tape 140.

FIG. 1 also shows a cross-section of the APA laminated tape 140 showing its composition as an aluminum layer 142 on the inside, followed by a polypropylene layer 144 in the middle, and an aluminum layer 146 on the outside. As stated above, APA tape 140 is covered by the outer sheath 150.

The cable 100 shown in FIG. 1 does not include any waterproofing inside the outer sheath 150 and, therefore, can be susceptible to water penetration is the outer sheath 150 is physically penetrated.

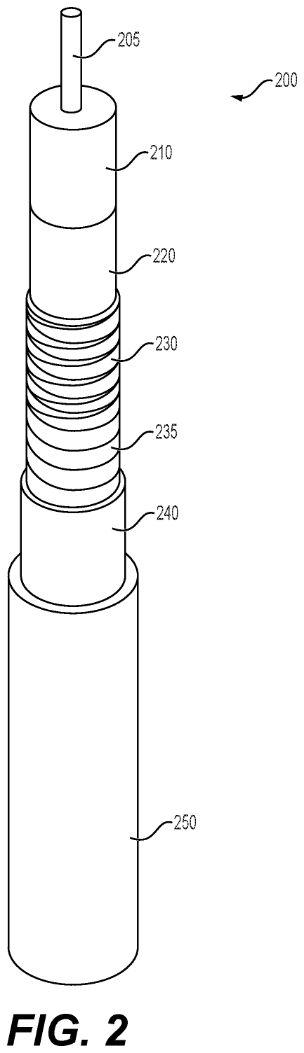

FIG. 2 shows an example of a cable 200 that incudes waterproofing inside the outer sheath. The cable in FIG. 2 has a center conductor 205 surrounded by a dielectric layer 210. The dielectric layer 210 is covered by an APA tape 220 that is an RF shield. In this example, an aluminum braid shield 230 covers the APA tape 220. A water blocking tape 235 is wound around the aluminum braid shield 230 in a spiral winding configuration. A second APA tape 240 covers the water blocking tape 235. An outer protective sheath 250 covers the APA tape 240.

The water blocking tape 235 in the cable 200 is wound onto the aluminum braid shield 230 in a spiral configuration to form a barrier to water that penetrates the outer sheath 250 and the APA tape 240. During assembly of the cable 200, winding the water blocking tape 235 onto the aluminum braid shield 230 adds a step to the assembly and adds thickness to the finished cable 200.

Embodiments of the disclosure provide a single tape that is constructed with four layers. For example, some embodiments have a laminated construction including a layer of aluminum, a layer of polypropylene, a layer of aluminum, and a layer of an absorbent powder that swells when in contact with water. The absorbent powder swelling on contact with water creates a physical barrier that impedes the further flow of the water in the cable. In embodiments, the tape would be applied in a step similar to how APA tape is applied. In some embodiments, a water blocking tape is bonded to an APA laminated tape before the composite tape is applied to cable. Embodiments provide both electrical shielding and water blocking capabilities in a single source solution and minimizes material thickness.

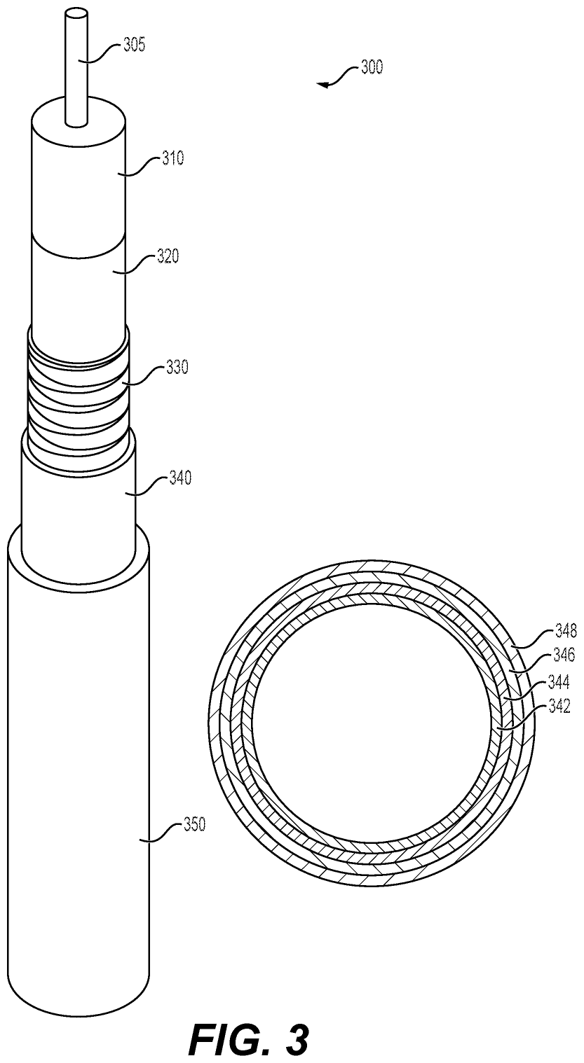

FIG. 3 shows an example of a cable 300 in accordance with embodiments of the invention. The cable 300 in FIG. 3 has a center conductor 305 surrounded by an insulator portion, for example, a dielectric layer, 310. The dielectric layer 310 is covered by a first shielding portion, for example, a first shielding layer, or an aluminum-polypropylene-aluminum (APA) tape, 320 that is an RF shield. In this example, a second shielding portion, for example, a second shielding layer, or an aluminum braid shield, 330 covers the APA tape 320. A composite portion, for example, a four layer tape, 340 covers the aluminum braid shield 330. A sheath portion, for example, an outer protective sheath, 350 covers the four layer tape 340.

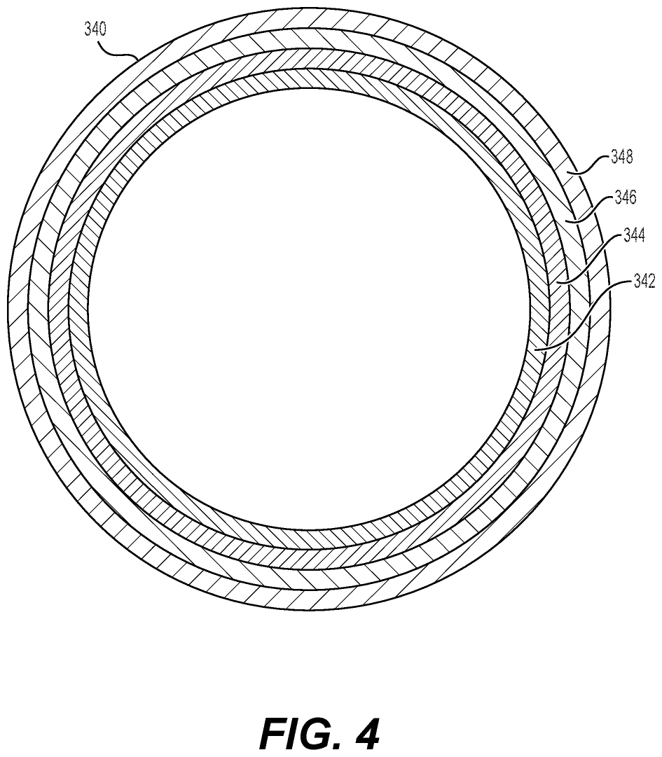

FIGS. 3 and 4 show a cross-sectional view of four layer tape 340. In this example, tape 340 has a composite portion first shield portion, for example, a first metal layer, or a first aluminum layer, 342 on the inside, followed by a composite portion polypropylene layer 344, a composite portion second shield portion, for example, a second metal layer, or a second aluminum layer, 346, and then a composite portion water blocking portion, for example, a water blocking layer, 348 on the outside of the second aluminum layer 346. In embodiments, the water blocking layer 348 is a layer of absorbent powder. The absorbent powder provides a water blocking layer that is thinner than a waterproofing tape (as in FIG. 2) and still effective at blocking water due to the absorbent nature of the absorbent powder. In other embodiments, waterblocking layer 348 is a water blocking tape that is bonded to the outside of the second aluminum layer 346. Both the absorbent powder and bonded water blocking tape embodiments provide a thinner alternative to a separate water blocking tape as shown in FIG. 2. These embodiments provide both electrical shielding and water blocking capabilities in a single source solution and minimizes material thickness.

The term “adjacent” is understood to mean that there is no intermediate structure between two items, but does not necessarily mean that the two items touch each other.

Some of the above exemplary embodiments include applying an absorbent powder to a shielding tape. Other embodiments include applying shielding to a powdered tape.

In embodiments, the tape 340 is wrapped around the aluminum braid shield 330 in, for example, a spiral pattern. In other embodiments, the tape 340 is folded over the aluminum braid shield 330 with a longitudinal seam running in the direction of the center conductor 305 of the cable 300.

Although the illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

Various changes to the foregoing described and shown structures will now be evident to those skilled in the art. Accordingly, the particularly disclosed scope of the invention is set forth in the following claims.

What is claimed is:

1. A cable comprising:
a center conductor;
a cable insulator portion surrounding the center conductor;
a first shielding portion surrounding the cable insulator portion;
a second shielding portion surrounding the first shielding portion;
a composite portion surrounding the second shielding portion, the composite portion comprising
a composite portion first shield portion;
a composite portion insulating portion surrounding the composite portion first shield portion;
a composite portion second shield portion surrounding the composite portion insulating portion;
a composite portion water blocking portion surrounding the composite portion second shield portion;
a sheath portion surrounding the composite portion;
wherein the composite portion insulator portion is adjacent to the composite portion first shield portion, the composite portion second shield portion is adjacent to the composite portion insulating portion, and the composite portion water blocking portion is adjacent to the composite portion second shield portion;
wherein the composite portion first shield portion, the composite portion insulating portion, the composite portion second shield portion, and the composite portion water blocking portion form a single unit that is configured to be applied to an outside of the second shielding portion as the single unit; and
wherein the composite portion provides radio frequency shielding and water blocking in a single tape so as to provide radio frequency shielding and water blocking in a compact cable.

2. The cable of claim 1, wherein the cable insulator portion surrounds the center conductor in a radial direction, the first shielding portion surrounds the cable insulator portion in the radial direction, the second shielding portion surrounds the first shielding portion in the radial direction, the composite portion surrounds the second shielding portion in the radial direction, and the sheath portion surrounds the composite portion in the radial direction.

3. The cable of claim 1, wherein the first shielding portion is an aluminum-polypropylene-aluminum layer.

4. The cable of claim 3, wherein the second shielding portion is an aluminum braid layer.

5. The cable of claim 1, wherein the composite portion is a four-layer tape.

6. The cable of claim 1, wherein the composite portion water blocking portion is an absorbent powder.

7. The cable of claim 1, wherein the composite portion water blocking portion is a water blocking tape.

8. The cable of claim 1, wherein the composite portion is configured to be wound around the second shielding portion in a helical formation.

9. The cable of claim 1, wherein longitudinal edges of the composite portion are configured to form a folded seam running in a direction of the center conductor of the cable.

10. A composite water blocking shield for use in a cable comprising:
a first shield portion;
an insulator portion surrounding the first shield portion;
a second shield portion surrounding the insulator portion;
a water blocking portion surrounding the second shield portion;
wherein the insulator portion is adjacent to the first shield portion, the second shield portion is adjacent to the insulator portion, and the water blocking portion is adjacent to the second shield portion;
wherein the first shield portion, the insulator portion, the second shield portion, and the water blocking portion form a single tape that is configured to be applied to an outside of a portion of a cable as a single unit; and
wherein the composite water blocking shield provides radio frequency shielding and water blocking in a single tape so as to provide radio frequency shielding and water blocking in a compact cable.

11. A cable comprising:
a center conductor;
a cable insulator portion surrounding the center conductor;
a shielding portion surrounding the cable insulator portion;
the composite water blocking shield of claim 10 surrounding the shielding portion.

12. The cable of claim 11, wherein the composite water blocking shield is configured to be wound around the shielding portion in a helical formation.

13. The cable of claim 11, wherein longitudinal edges of the composite water blocking shield are configured to form a folded seam running in a direction of the center conductor of the cable.

14. The composite water blocking shield of claim 10, wherein the composite water blocking shield is a four-layer tape.

15. The composite water blocking shield of claim 10, wherein the water blocking portion is an absorbent powder.

16. The composite water blocking shield of claim 10, wherein the water blocking portion is a water blocking tape.

17. A composite water blocking shield for use in a cable comprising:
a first shield portion;
an insulator portion adjacent to the first shield portion;
a water blocking portion surrounding the insulator portion;
wherein the first shield portion, the insulator portion, and the water blocking portion form a single tape that is configured to be applied to an outside of a portion of a cable as a single unit; and
wherein the composite water blocking shield provides radio frequency shielding and water blocking in a single tape so as to provide radio frequency shielding and water blocking in a compact cable.

18. The composite water blocking shield of claim 17, further comprising a second shield portion adjacent to the insulator portion.

19. The composite water blocking shield of claim 18, wherein the insulator portion is adjacent to the first shield portion, the second shield portion is adjacent to the insulator portion, and the water blocking portion is adjacent to the second shield portion.

20. The composite water blocking shield of claim 17, wherein the water blocking portion is an absorbent powder.

21. The composite water blocking shield of claim 17, wherein the water blocking portion is a water blocking tape.

22. The composite water blocking shield of claim 17, wherein the composite water blocking shield is configured to be wound around a portion of a cable in a helical formation.

23. The composite water blocking shield of claim 17, wherein longitudinal edges of the composite water block shield are configured to form a folded seam running in a direction of a center conductor of a cable.
